(19) United States
(12) Patent Application Publication
(10) Pub. No.: US 2007/0035226 A1
(43) Pub. Date: Feb. 15, 2007

(54) Carbon nanotube hybrid structures

(75) Inventors: Ramanath Ganapathiraman, Clifton Park, NY (US); Saurabh Agrawal, Troy, NY (US)

Correspondence Address: FOLEY AND LARDNER LLP;SUITE 500, 3000 K STREET NW, WASHINGTON, DC, 20007, US

(73) Assignee: Rensselaer Polytechnic Institute

(21) Appl. No.: 11/384,524

(22) Filed: Mar. 21, 2006

Related U.S. Application Data
(63) Continuation-in-part of application No. 10/361,640, filed on Feb. 11, 2003.
(60) Provisional application No. 60/663,704, filed on Mar. 21, 2005.
(60) Provisional application No. 60/356,069, filed on Feb. 11, 2002.
(60) Provisional application No. 60/385,393, filed on Jun. 3, 2002.

(51) Int. Cl. H01J 1/00; D01F 9/12; H01J 1/02; H01J 19/06

(52) U.S. Cl. 313/309; 313/311; 313/351; 423/447.1

(57) ABSTRACT

Hybrid structures include aligned carbon nanotube bundles grown on curved surfaces such as micro sized or nano sized particles or bulk substrates having micro size or nano sized protrusions. The morphology of the hybrid structures can controlled by varying the size and packing of the particles or protrusions.

### CROSS-REFERENCE TO RELATED PATENT APPLICATIONS

This application is a continuation-in-part of U.S. patent application Ser. No. 10/361,640, filed Feb. 11, 2003, which claims priority to U.S. Provisional Patent Applications Nos. 60/356,069, filed Feb. 11, 2002, and 60/385,393, filed Jun. 3, 2002. This application also claims priority to U.S. Provisional Patent Application No. 60/663,704, filed Mar. 21, 2005. All of the above applications are incorporated herein by reference in their entirety.

### STATEMENT REGARDING FEDERALLY SPONSORED RESEARCH OR DEVELOPMENT

This invention was made with government support under the Office of Naval Research grant No. N00014-00-1-2050 and the National Science Foundation grants Nos. DMI-0304028 and DMR 9984478. The United States government may have rights in this invention.

### FIELD OF THE INVENTION

The present application relates generally to carbon nanotubes and more particularly to carbon nanotube—micro or nanoparticle hybrids and methods of making such hybrids.

### BACKGROUND

Carbon nanotubes (CNTs) exhibit fascinating electrical, thermal, and optical properties, and remarkable mechanical stability, which makes these unique one-dimensional nanostructures promising candidates for use in a variety of devices and composites. For review of carbon nanotubes and their properties, see e.g. Y. Huang, X. Duan, Y. Cui, L. J. Lauhon, K. H. Kim, C. M. Lieber, Science 2001, 294, 1313; X. Duan, Y. Huang, R. Agarwal, C. M. Lieber, Nature 2003, 421, 241; Y. Cui, Q. Wei, H. Park, C. M. Lieber, Science 2001, 293, 1289; J. Kong, N. R. Franklin, C. Zhou, M. G. Chapline, S. Peng, K. Cho, H. Dai, Science 2000, 287, 622; M. R. Falvo, R. M. Taylor, A. Helser, V. Chi, F. P. Brooks, S. Washburn, R. Superfine, Nature 1999, 397, 236; M. F. Yu, O. Lourie, M. J. Dyer, K. Moloni, T. F. Kelly, R. S. Ruoff, Science 2000, 287, 637; J. P. Lu, Phys. Rev. Lett. 1997, 79, 1297.

A considerable progress has been achieved in growing aligned CNT bundles in predetermined orientations on planar substrates by chemical vapor deposition (CVD), see e.g. B. Q. Wei, R. Vajtai, Y. Jung, J. Ward, R. Zhang, G. Ramanath, P. M. Ajayan, Nature 2002, 416, 495; J. Kong, H. T. Soh, A. M. Cassell, C. F. Quate, H. Dai, Nature 1998, 395, 878; K. Hata, D. N. Futaba, K. Mizuno, T. Namai, M. Yumura, S. Iijima, Science 2004, 306, 1362; V. Bajpai, L. M. Dai, and T. Ohashi, J. Am. Chem. Soc. 2004, 126, 5070; B. Q. Wei, R. Vajtai, Y. Jung, J. Ward, R. Zhang, G. Ramanath, P. M. Ajayan, Chem. Mater. 2003, 15, 1598. Typical CVD approaches to grow oriented CNTs involve lithographic templating and activation of catalyst-containing nanoparticles or thin films on the substrate, or combining gas-phase catalyst delivery and substrate-selective catalyst activation on certain portions of patterned surfaces.

Although recent work has shown that the fabrication of hybrid nanostructures comprising CNTs and nanoparticles or nanowires is possible, see e.g. S. Huang, Carbon 2003, 41, 2347; Z. P. Huang, D. L. Carnahan, J. Rybczynski, M. Giersig, M. Sennett, D. Z. Wang, J. G. Wen, K. Kempa, Z. F. Ren, Appl. Phys. Lett. 2003, 82, 460; T. Sainsbury, D. Fitzmaurice, Chem. Mater. 2004, 16, 3780; Y. L. Gu, L. Y. Chen, Z. F. Li, Y. T. Qian, W. Q. Zhang, Carbon 2004, 42, 235, B. Q. Wei, J. W. Ward, R. Vajtai, R. Ma, P. M. Ajayan, G. Ramanath, Chem. Phys. Lett. 2002, 354, 264-268, L. Ci, J. Bai, Adv. Mater. 2004, 16, 2021, the orientation of CNTs on nanoparticles in these nanostructures was random.

### SUMMARY

One embodiment of the invention includes a structure, comprising at least one microsized or nanosized curved surface and a plurality of aligned carbon nanotube bundles grown on the curved surface.

### BRIEF DESCRIPTION OF THE DRAWINGS

FIGS. 1 a-d are SEM images showing (a) CNT pillars grown over 6.84 μm silica spheres; (b) forest of aligned CNTs formed by close packed assembly of spheres; (c) a wall formed from aligned CNTs grown on a chain of closely spaced spheres; (d) top-view of CNT pillars grown on isolated spheres.

FIGS. 2 a-e are SEM images showing random CNT growth over silica spheres of different diameters: (a) 2.4 μm, (b) 490 nm, (c) 400 nm. High magnification SEM images show (d) clean CNTs grown on 490 nm silica spheres, and (e) amorphous C with Fe nanoparticles on 400 nm silica spheres exposed to the CVD precursors. FIG. 2f is a TEM micrograph showing Fe nanoparticles (bright due to high atomic number contrast) and amorphous carbon.

FIG. 3a presents Raman spectra showing D and G bands from CNTs grown on silica spheres of different diameters (shown alongside the curves).

FIG. 3b is a plot of D band-G band intensity ratio as function of silica sphere diameter.

### DETAILED DESCRIPTION

The inventors developed a methodology that allows for growing aligned carbon nanotubes or carbon nanotube bundles on at least micro and nanosized particles. The methodology also allows controlling the alignment of carbon nanotube bundles by adjusting the particle size and packing.

The methods for growing carbon nanotubes on non-planar confined geometries, in the micron and submicron range, such as microsized or nanosized particles, can open up new ways for organizing CNTs for devices, through the application of colloidal chemistry techniques on the particle-CNT hybrid building blocks.

The terms “carbon nanotube bundle” and “carbon nanotube pillar” are used interchangeably, each referring to structures comprising a plurality of carbon nanotubes that are meandered or roped within the bundle or pillar and that are pointing in the same direction.

The term “curved surface” refers to surfaces of confined geometries having curvature radius of micro or nanometer size.

Aligned carbon nanotubes or nanotube bundles can be grown on a surface of microsized or nanosized particle of any material. In some embodiments, aligned carbon nanotubes or nanotube bundles may be formed on the surfaces of oxide particles, such as silica, alumina, MgO, MnO, HfO₂, Gd₂O₃, indium tin oxide and other metal oxide particles. Carbon nanotube bundles can be also grown on surface of non-oxide particles. Preferably, the particles are substantially spherical particles, such as spherical, oval and roughly spherical (i.e., generally spherical particles with one or more planar or angular surfaces) particles. The particles may be micro sized (preferably 1 to 1,000 micron diameter), macro sized (preferably 1,000 microns to 1 cm diameter) or nano sized (200 nm to 1 micron). The particles may be located on horizontal or non-horizontal substrate surfaces. For example, the particles may be located on a vertical substrate surface. If desired, the substrate may be omitted and the particles may be suspended in a fluid.

Aligned carbon nanotube bundles can be also grown on curved surfaces other than microsized or nanosized particles. For example, the aligned carbon nanotubes can be grown on a surface of a bulk (i.e., non-particle) substrate of any convexity that mimics a microsized or nanosized particle. Convexities, such as micro or nano scale protrusions can be formed on the bulk substrate by known methods such as lithography or roughening. The curved surface may comprises a horizontal or non-horizontal (such as vertical) bulk substrate surface. The morphology of the hybrid nanotube bundle/curved surface structures can controlled by varying the size and/or packing of the particles or protrusions.

Carbon nanotube bundles can comprise single wall carbon nanotubes or multiwalled carbon nanotubes. Aligned carbon nanotubes can be grown over a micro or nanosized curved bulk or particle surface by any method if it satisfies geometrical requirements, i.e. requirements on size and density or packing, discussed below.

In some embodiments, the growth of nanotubes can be achieved without metal catalyst predeposition. Instead CVD nanotube growth can be stimulated by exposing the substrate or particles to vapor mixtures comprising xylenes (C₈H₁₀), a nanotube-forming precursor, and ferrocene (Fe(C₅H₅)₂), a nanotube catalyst, at about 600 to 1100° C., preferably at about 725 to 825° C. However, other suitable source gases and temperatures may be used instead. Ferrocene can be dissolved in xylenes (which preferably contains different isomers) at concentrations of about 0.01 g/ml, the mixture can be pre-heated, co-evaporated and fed into the CVD chamber. The reactants preferably comprise of 0.001 to 1 percent of the ferrocene/xylenes mixture. The details of method of growing nanotubes without metal catalyst predisposition can be found in Zhang et. al. Applied Physics Letters, vol. 77, p. 3764, 2000.

In an alternative method, nanotube growth can be performed by depositing catalyst islands on the bulk or particle curved surface using an AFM tip, lithography, spin-on coating or other deposition methods, and then exposing the catalyst islands to a carbon-containing source gas at an elevated temperature. The catalyst islands can comprise, for example, Fe₂O₃ or other catalysts materials including molybdenum, cobalt, nickel, zinc, or oxides thereof. The carbon containing gas can be, for example, methane or another hydrocarbon gas. Details of growing carbon nanotubes on catalyst islands can be found, for example, in U.S. Pat. No. 6,346,189 to Dai et. al. The carbon nanotube growth method that includes depositing catalyst islands can be used to grow nanotubes on non-oxide surfaces.

The alignment of carbon nanotube bundles can be controlled by adjusting the size of the particles and their packaging or density. If the size of a particle is no less than a first critical diameter (D₁), then aligned carbon nanotube bundles can grow in a direction normal to the surface of the particle, independent of whether the particle is close packed or isolated. If the size of a particle is greater than a second critical diameter (D₂) and less than D₁, then aligned carbon nanotube bundles can grow in a direction normal to the surface of the particle, if the particles are closely packed, and in a direction that is not normal to the surface, when the particles are isolated particles. When the size of the particle is less than D₂ but greater than a third critical diameter D₃, carbon nanotubes grow on the particles in a random manner without any alignment. The density of carbon nanotubes decreases in the range between D₃ and a fourth critical diameter D₄ as significant amount of amorphous carbon accompanies carbon nanotubes. When diameter is below D₄, nanotubes do not grow on the surface of the particles. Particular values of D₁, D₂, D₃ and D₄ depend on material of the particles and on carbon nanotube growth rate. For example when CNT growth rate increase, then particle size which corresponds to D₁, D₂, D₃ and D₄ decreases and/or the bundle alignment increases.

Whether or not carbon nanotubes form aligned bundles can determined by known experimental techniques such as scanning electron microscopy (SEM) or reflection high energy electron diffraction (RHEED).

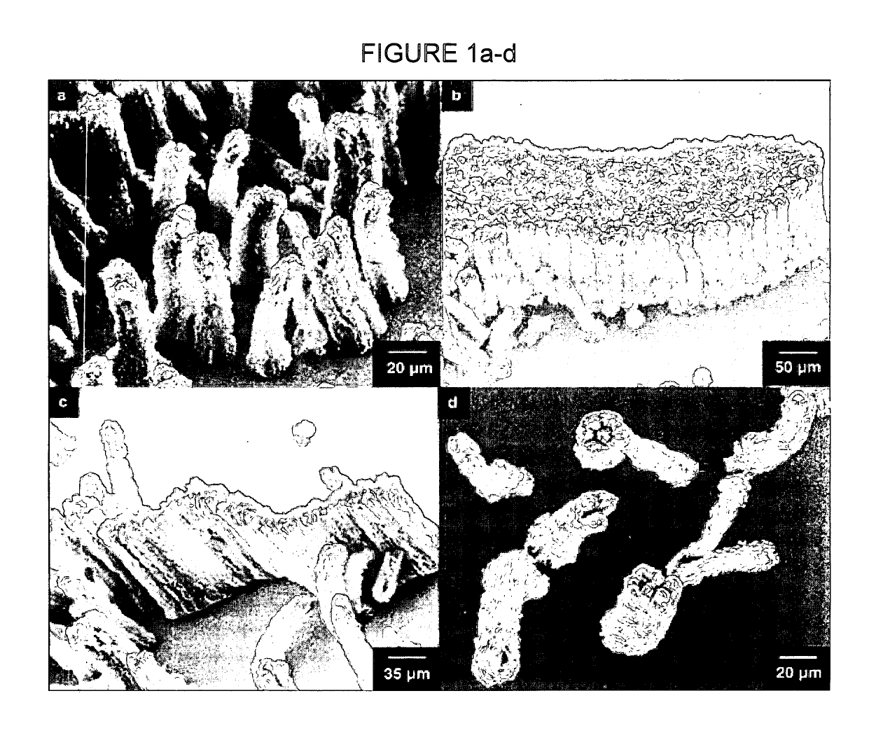

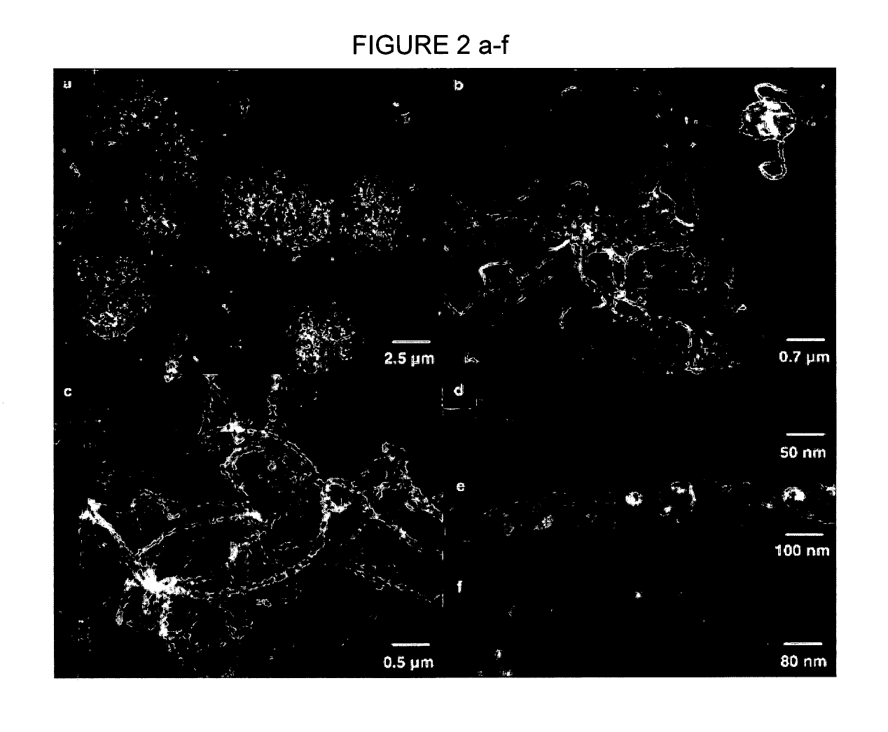

For example, FIGS. 1a-d and 2a-e present SEM images illustrating size and packing dependence for carbon nanotubes grown on silica micro and nanoparticles deposited on a silicon substrate. The carbon nanotubes were grown by a method that does not include predisposition of catalyst on the surface of silica particles. For silica particles, D₁ is about 4.1 microns. As exemplified for 6.84 μm diameter particles in FIG. 1a, densely aligned CNT pillars grow in a direction normal to the silicon substrate. The morphology of the CNT pillars is similar to that obtained on planar silica substrates. The CNTs in the pillars are wavy, similar to other CVD-grown nanotubes, with an average inter-CNT distance such that the CNT density is 1010 cm⁻², see J. S. Suh, J. S. Lee, Appl. Phys. Lett. 1999, 75, 2047. The size of the CNT bundles scales with increasing particle diameter. FIG. 1b demonstrates carbon nanotube bundles grown on closely packed assemblies of 6.84 μm diameter microparticles deposited on a substrate. The bundles grow in the direction perpendicular to the substrate and form a continuous film. FIG. 1c shows wall-like architectures comprising carbon nanotube bundles formed on linear chains of microsized particles of 6.84 μm diameter. FIG. 1d presents CNT bundles grown on isolated microsized particles 6.84 μm in diameter. Although the CNTs are aligned within the bundles, the bundles themselves are oriented not vertically with respect to the substrate. Decreasing the diameter of silica particles below D₂˜2.4 microns yields carbon nanotubes, but without any alignment (see FIG. 2a). Further decrease down to D₃˜490 nm results is a sharp decrease in the CNT number density (see FIG. 2b) with a large amount of amorphous carbon present on the CNTs. As illustrated in FIGS. 2c-e the amorphous carbon can be present on the CNT surface in a form of nanoparticles, giving rise to a rough morphology. In addition, a large number of Fe-containing nanoparticles can be observed on the CNT surface, as shown in the TEM image in FIG. 2f. No CNT growth is observed on nanosized silica particles with diameters below 330 nm.

The nanotube structures can be grown on microsized or nanosized particles deposited on a substrate by colloidal chemistry methods. For example, the particle can be suspended in a solvent and then drop-cast on a clean substrate surface. The particle assembly density on the substrate can be varied by adjusting a concentration of the particles in the suspension and/or by tilting the substrate. The samples can then be dried to remove the excess solvent.

Alternatively, the nanotube structures can be grown in patterned particle structures or architectures. For example, combination of colloidal chemistry and lithography can be applied to form a pattern of micro or nanosized particles on the substrate. Then, carbon nanotube bundles grown on the particles will follow the pattern. Example of such patterned structure is shown in FIG. 1c.

The carbon nanotube structures can be utilized in devices, such as electronic devices. For example, the patterned structures can be used in electronic switching, memory storage, sensing and actuation devices. The structures can also be used in field emission devices (FEDs). The aligned CNT bundles act as electron emitting field emission cathodes in these devices. For example, CNT bundles grown on roughened bulk substrate surfaces described above can have a few degree distribution in their orientation, which can help to avoid smearing effect found in conventional FEDs. Alternatively, a monolithic structure comprising aligned CNT bundles grown on individual particles can be used as optical labels or radio frequency ID tags in a fluid environment, such as for in-vivo diagnostics.

The embodiments of the present invention can be illustrated in more details by the following example, however, it should be understood that the present invention is not limited thereto.

### WORKING EXAMPLE

Silica microspheres of chosen diameters between 6.84 μm and 160 nm were drop coated from a dilute suspension in acetone onto device quality Si(001) wafers pre-cleaned successively in ultrasonic baths of trichloroethylene, acetone and isopropyl alcohol. The nanoparticle assembly density was controlled by adjusting the acetone suspension concentration, and substrate tilting. The samples were dried at room temperature for ˜1 hour to remove acetone to obtain silica particle assemblies on the substrate. Carbon nanotubes (CNTs) were grown by exposing these samples to a xylene-ferrocene mixture in a vacuum tube furnace at 775° C. in 100 sccm Ar, known to yield CNT growth selectively on silica in exclusion to silicon, as described in B. Q. Wei, R. Vajtai, Y. Jung, J. Ward, R. Zhang, G. Ramanath, P. M. Ajayan, Chem. Mater. 15, 1598 (2003) incorporated herein by reference in its entirety. The CNT morphology was characterized by SEM in a JEOL 6330F FESEM microscope operated at 5 kV. Raman spectroscopy was conducted using a Renishaw Ramanscope system with a 514 nm Argon laser.

Densely aligned CNT pillars grow on >4.1 μm-diameter silica microspheres in a direction normal to the silicon substrate (see FIG. 1a). The morphology is similar to that obtained on planar silica substrates, indicating that the selective CVD process is extendable to growing micron size CNT bundles on nanoparticles. The CNTs are wavy, similar to other CVD-grown tubes, see V. Bajpai, L. M. Dai, and T. Ohashi, J. Am. Chem. Soc. 2004, 126, 5070, with an average inter-CNT distance such that the CNT density is ˜10¹⁰ cm⁻². The size of the CNT bundles scales with increasing sphere diameter. CNTs form a continuous film when grown on closely packed assemblies of the microparticles (see FIG. 1b). Macroscopic wall-like architectures comprising columns of CNT bundles are formed on linear chains of micropheres (see FIG. 1c). This feature can be conceivably used to harness organized patterns of silica microspheres assembled by combining colloidal chemistry and lithography to create CNT-confined cellular patterns on planar substrates. While the CNTs grown on isolated microspheres are aligned within the bundle, the bundles are not vertically oriented with respect to the substrate in most cases (see FIG. 1d). This observation may suggest that support from the bundles from neighboring spheres can be important for vertical alignment.

Decreasing the diameter of silica microspheres below ˜2.4 μm yields CNTs, but without any alignment (see FIG. 2a). Further decreases in silica sphere diameter up to ˜490 nm results in a sharp decrease in the CNT number density (see FIG. 2b). CNTs grown on sub-400-nm silica nanoparticles are covered with a large amount of amorphous carbon (see Raman spectroscopy results described below). The amorphous carbon is present as nanoparticles on the CNT surface (see FIG. 2c-e), giving rise to a rough morphology. In addition, a large number of Fe-containing nanoparticles are observed (see FIG. 2f). No CNT growth is observable on nanospheres below 330 nm.

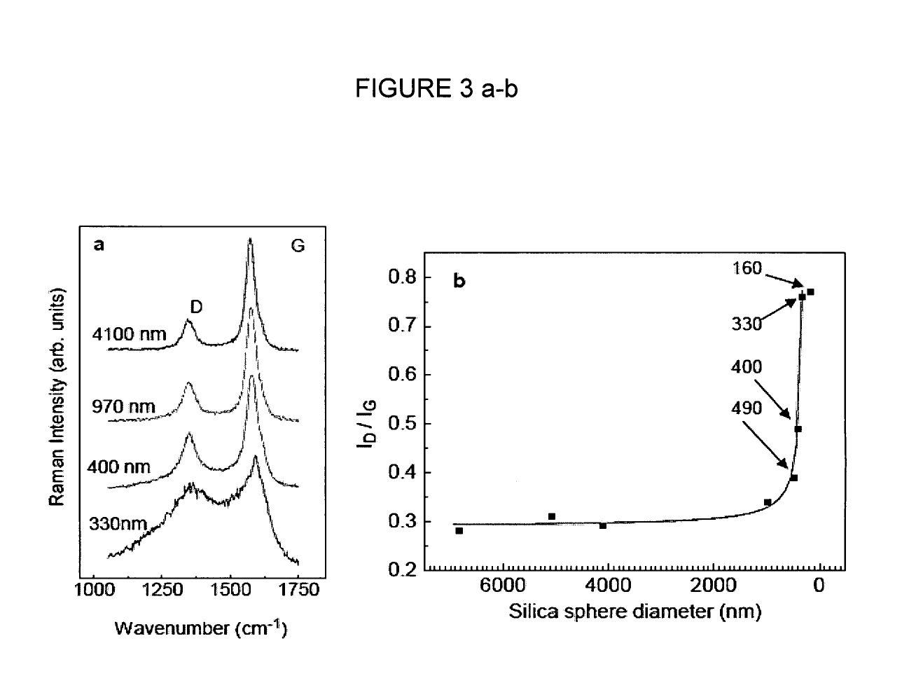

Raman spectroscopy of the CNT-silica sphere heterostructures shows that the gradual decrease in CNT number density correlates with the increased disorder attributed to the formation of sp3 carbon, see A. C. Ferrari, J. Robertson, Phys Rev B 2000, 61, 14095. FIG. 3a shows example spectra showing an increase in the D band (1350 cm⁻¹) intensity with decreasing sphere diameter when normalized with respect to the G band (1580 cm⁻¹) intensity. FIG. 3b shows the D-G intensity ratio as a function of microsphere size. For CNT grown on microsphere diameters 4.1 μm and above, the ratio is nearly constant at ˜0.3, which corresponds to that in multiwalled CNTs grown over planar substrates 21. For smaller sphere diameters up to 490 nm the disorder increases gradually to 0.39 due to a gradual increase in the amount of amorphous carbon with respect to the amount of CNT deposited. However, below 490 nm the disorder increases in an asymptotic manner to ˜0.5 due to deposition of amorphous carbon, described above (FIGS. 2e-f). These results can be captured in an empirical relationship where the ratio of D-band to G-band intensity is given by I_{D}/I_{G}=A+B/(d−C), where d is the diameter of the microsphere in nm. The constants A, B and C are 0.29, 28 and 270 respectively in case of SiO₂ microspheres. This relationship is valid only in the range where d more than about 330 nm. For sphere diameter less than about 330 nm the ratio saturates at ˜0.77, corresponding to that observed from amorphous carbon annealed in N₂ to 800° C. which is similar to the used CNT growth temperature, see V. I. Merkulov, J. S. Lannin, C. H. Munro, S. A. Asher, V. S. Veerasamy, W. I. Milne, Phys. Rev. Lett. 1997, 78, 4869.

The continuous change in morphology from aligned CNT bundles to randomly oriented CNTs with decreasing silica particle size can be understood as follows. Aligned CNT grow normal to the surface of large microspheres due to the reduction in energy obtained by coordinated van der Waals interactions between adjacent CNTs, in a manner similar to that observed in self-assembled molecular layers (SAMs). Although the intertube spacing is ˜20-30 nm, the waviness of the CNTs causes adjacent tubes cross each other within van der Waals interaction distance at different points along their lengths, enabling a net lateral attractive force between the CNTs. The same effect also drives alignment of bundles on adjacent microspheres. The high curvature on smaller microspheres results in a smaller number of CNTs separated by large angular separations. Both factors decrease the number of crossing points, and the extent of the lateral reinforcing force, hence resulting in random CNT growth which gradually disappears due to preference for amorphous carbon formation.

In summary, CNT nucleation and morphology on microparticles are strongly dependent on the particle size and packing. By adjusting these parameters, the CNT growth and orientation can be controlled. Novel morphologies can be obtained by dispersing the spheres on substrates that inhibit CNT growth. Geometrical confinement below a critical particle size inhibits the growth of aligned CNT bundles due to deposition of amorphous carbon and the high angular spacing between a smaller number of bundles which are unfavorable for laterally reinforced alignment of the CNTs by van der Waals forces. This lateral size dependence of the substrate surface will be an important factor that may limit the growth of highly oriented one-dimensional nanostructures on nanoscale patterns.

Although the foregoing refers to particular preferred embodiments, it will be understood that the present invention is not so limited. It will occur to those of ordinary skill in the art that various modifications may be made to the disclosed embodiments and that such modifications are intended to be within the scope of the present invention.

All of the publications, patent applications and patents cited herein are incorporated herein by reference in their entirety.

What is claimed is:

1. A structure, comprising:
(i) at least one microsized or nanosized curved surface; and
(ii) a plurality of aligned carbon nanotube bundles grown on the curved surface.

2. The structure of claim 1, wherein the curved surface is a surface of a microsized particle.

3. The structure of claim 2, wherein the microsized particle is an oxide particle.

4. The structure of claim 2, wherein the microsized particle is a spherical, oval or roughly spherical particle.

5. The structure of claim 2, wherein said microsized particle is an isolated particle deposited on a substrate.

6. The structure of claim 2, wherein said microsized particle comprises one of a plurality of densely packed particles deposited on a substrate.

7. The structure of claim 6, wherein said bundles are aligned perpendicular to the substrate.

8. The structure of claim 1, wherein the curved surface is a surface of a nanosized particle.

9. The structure of claim 1, wherein said curved surface is a convex surface of a bulk substrate having nanosized or microsized protrusions.

10. The structure of claim 1, wherein said carbon nanotube bundles comprise multiwalled carbon nanotubes.

11. The structure of claim 1, wherein said carbon nanotube bundles comprise single walled carbon nanotubes.

12. The structure of claim 1, wherein:
the curved surface comprises surfaces of a plurality of closely packed microsized or nanosized particles disposed on a substrate; and
the bundles grown on each of said plurality of particles together form a continuous film.

13. The structure of claim 1, wherein:
the curved surface comprises surfaces of a plurality of closely packed microsized or nanosized particles forming a pattern on a substrate; and
the bundles grown on each particle of said plurality form together a architecture determined by said pattern.

14. A method of making carbon nanotube structures, comprising
(a) providing at least one nanosized or microsized curved surface;
(b) providing a nanotube source gas to the surface;
(c) growing aligned carbon nanotube bundles on the curved surface.

15. The method of claim 14, wherein the nanotube source gas comprises xylenes and ferrocene provided to the curved surface in a chemical vapor deposition apparatus.

16. The method of claim 14, wherein said surface is a surface of a microsized particle.

17. The method of claim 16, wherein the micro sized particle is an oxide particle.

18. The method of claim 16, wherein the micro sized particle is a spherical, oval or roughly spherical particle.

19. The method of claim 16, wherein step (a) comprises disposing said microsized particle on a substrate.

20. The method of claim 19, wherein step (a) comprises disposing a plurality of microsized particles from a colloidal solution.

21. The method of claim 16, further comprising selecting an alignment direction of said carbon nanotube bundles by selecting at least one of a size and packing of said micro particle.

22. The method of claim 14, further comprising depositing a nanotube growth catalyst on the curved surface.

23. An optical label or an RFID tag for use in a fluid environment comprising the structure of claim 1.

24. A field emission device comprising the structure of claim 9.
